(19) United States
(12) Patent Application Publication
(10) Pub. No.: US 2023/0180800 A1
(43) Pub. Date: Jun. 15, 2023

(54) SEAWEED BINDER-CONTAINING PULSE BASED FOOD PRODUCTS AND METHODS OF PRODUCING SAME

(71) Applicant: TSUBASA HOLDINGS, LLC, Edina, MN (US)

(72) Inventors: Akhiko Sugata, Edina, MN (US); Keisuke Sawakawa, Torrance, CA (US)

(21) Appl. No.: 17/917,387

(22) PCT Filed: Apr. 6, 2021
(86) PCT No.: PCT/US2021/025930

§ 371 Date: Oct. 6, 2022

Related U.S. Application Data
(60) Provisional application No. 63/008,143, filed on Apr. 10, 2020.
(60) Provisional application No. 63/036,030, filed on Jun. 8, 2020.

(51) Int. Cl. A23L 11/00; A23L 17/60; A23L 33/00; A23L 7/109; A21D 13/066

(52) U.S. Cl. CPC A23L 11/05; A23L 17/60; A23L 33/40; A23L 7/109; A21D 13/066

(57) ABSTRACT

A gluten-free, pulse-based food product includes pulse flour, a seaweed powder binder that is chemically unprocessed and retains alginate in native form within the seaweed powder, water, and optional minor ingredients. Methods of making the pulse-based food product involve mixing these components into a bound mass where the seaweed powder binder is the sole binder in the food product. The food product may be one of a dough, a noodle, a pasta, or a dumpling skin.

### CROSS-REFERENCE TO RELATED APPLICATIONS

This application claims priority to U.S. provisional patent application No. 63/008,143, filed Apr. 10, 2020 and U.S. provisional patent application No. 63/036,030, filed Jun. 8, 2020, each having the same title as the instant application, the contents of each of which are incorporated herein by reference in their entirety.

### TECHNICAL FIELD

Implementations provide pulse-based food products containing a seaweed powder binder and methods of making such pulse-based food products.

### BACKGROUND

Gluten-containing food products that contain wheat flour, for instance, include a framework of protein and starch due to the presence of gluten in the wheat flour. The framework is responsible for binding the flour to itself in foods such as bread, fresh noodle and dried pasta. Gluten-containing food products have come under fire in the recent years due to negative health effects experienced by consumers of these products.

Gluten-free products have gained momentum partly in response to the drawbacks of gluten. In addition, consumers are increasingly demanding plant-based protein sources. Pulse is a gluten-free and protein-rich food source that is becoming increasingly popular in the food industry. US 2019/0297927 teaches gluten-free food products containing pulse flour where the pulse protein, starch, fiber, and flour ingredients interact with themselves and each other to make matrixes, or gels, that create stable finished product forms including noodle and pasta. The reference explains that the pulse ingredients derive their functionality based on how the pulse ingredients are combined and with what stress, heat, and shear is applied to them. Pulse proteins, starches, and fiber ingredients can be flexible or rigid based on the amount of shear applied, as well as moisture, amount of non-moisture fluids, and amount of solids present at the time of shear application. The reference continues and explains the gluten free pasta products have the flavor and texture expected of wheat based traditional pasta without the need for wheat gluten, egg protein, dairy proteins, hydrocolloids, oil, or other non-pulse ingredient addition. US 2018/0360079 also teaches pulse-based food products including pasta and explains hydrated pulse dough is agglomerated by heat and moisture treatment.

### SUMMARY

Provided are food products and their methods of production that use binders in combination with pulse ingredients in view of Applicant's discovery that pulse ingredients alone are not sufficient to produce stable food products.

Implementations provide gluten-free, pulse-based food products, and systems and methods for their production. Such products contain a seaweed powder binder that is chemically unprocessed and retains alginate in native form, and may be one of a dough, a noodle, a pasta, or a dumpling skin. Production of the products involves mixing these components into a bound mass where the seaweed powder binder may be the sole binder in the food product.

According to an exemplary implementation, a gluten-free, pulse-based food product includes pulse flour, a seaweed powder binder that is chemically unprocessed and retains alginate in native form, water, and optional minor ingredients.

In various implementations and alternatives, the seaweed in the seaweed powder binder is from one or more of kombu, wakame, mozuku, or edible seaweeds from the order Laminariales, and may be primary or the sole binder in the food product. The seaweed powder binder may include a blend of powdered roots and powdered leaves. A particle size of the seaweed binder may be 40 μm or less. In such implementations and alternatives, the pulse flour may have a particle size of about 40 μm or less. The seaweed powder binder and the pulse flour may have about the same particle size distribution.

In various implementations and alternatives, the pulse flour accounts for over 90 wt % by dry weight of the food product, and the seaweed powder binder accounts for about 2 to about 10 wt % by dry weight of the food product. Optional minor ingredients may account for up to about 5 wt % by dry weight of the food product. The pulse flour may include a single source or two or more pulse sources. The food product may be free of chemical binders.

In various implementations and alternatives, the food product is one of a dough, a noodle, a pasta, or a dumpling skin. For instance, a dough may contain about 20-35 wt % water, about 70-90 wt % of the pulse flour, and about 2-10 wt % of the seaweed powder binder. The dough may be for forming the noodle, pasta, or dumpling skin.

According to another exemplary implementation, a method of forming a food product involves mixing pulse flour, a seaweed powder binder that is chemically unprocessed and retains alginate in native form within the seaweed powder, water and optional minor ingredients. In the mixed product, the seaweed powder binder is the primary binder in the food product, and the mixed product is gluten-free.

In various implementations and alternatives, where the food product is a noodle, the method further comprises forming the mixture into sheets, cutting the sheets into noodles, and cooking the noodles.

In addition to the exemplary aspects and embodiments described above, further aspects and embodiments will become apparent by reference to the drawings and by study of the following description.

### BRIEF DESCRIPTION OF THE DRAWINGS

FIG. 1 illustrates a method for producing pulse-based food products according to the present disclosure.

FIGS. 2-7 illustrate farino-plasto-charts for each of the control and test samples analyzed according to embodiments of the present disclosure.

FIGS. 8A-9D illustrate typical farinograms from flours of different strengths according to the prior art.

FIG. 9 illustrates a representative farinogram showing some commonly measured indices according to the prior art.

### DETAILED DESCRIPTION

Disclosed are natural, pulse-based food products containing a seaweed powder binder and methods of making such pulse-based food products. Seaweed powder binders provide advantages compared to pulse-based food products that do not contain the seaweed powder binder taught in prior approaches. Particularly, these prior approaches (US 2019/0297927 and US 2018/0360079) teach pulse-based food products that are free of non-pulse based ingredients including binders, and Applicant has discovered that such pulse-based products do not remain cohesive, and consequently, the seaweed powder binders disclosed herein, when used in combination with pulse flour, result in a natural, gluten-free, cohesive food product such as doughs, noodles (e.g., fresh noodles), pastas, dumpling skins, as well as other food products. Further, the seaweed powder binder is chemically unprocessed and retains alginate in native form within the seaweed powder.

This provides advantages over the use of alginate isolated from seaweed

Pulses are a member of the legume family that grow in pods, with the edible, dry seed of the pod being the pulse. Pulse sources commonly include chickpeas, lentils, dry peas, cow peas, black-eyed peas, pigeon peas, mung beans, faba beans, Bambara beans, vetches, lupin and dry beans, such as kidney beans, lima beans, butter beans and broad beans, and pulses nes (not elsewhere specified—e.g., minor pulses that do not fall within one of the preceding categories). Pulses are low-fat sources of protein, carbohydrates, are high in fiber and contain vitamins and nutrients. The protein content of some pulse crops range from 20-30%, which is significantly higher than protein in wheat (10-15%) and corn (6-8%).

Pulses are milled or ground into flour to provide pulse flour. The pulse flours of the present disclosure may be physically processed and not chemically processed. Non-chemically processed pulse flours may provide a base for natural food products. The pulse flour may be derived from one or more of the disclosed pulse sources. For example, the pulse flour may be derived from a single pulse source. For instance, lentil flour, pea flour or chickpea flour, mung bean flour, faba bean flour may be the preferred pulse flour sources. In other examples, the pulse flour may be a blend of two or more pulse sources such as 1-99% lentil flour, pea flour or chickpea flour, mung bean flour, faba bean flour, with the balance derived from one or more of the aforementioned pulse flour sources that is not the same as the lentil flour, pea flour or chickpea flour. In other examples, the pulse flour may be formed of 50% of a first pulse source and 50% from one or more other pulse sources, 25% of the first pulse source and 75% from one or more other pulse sources, 33% of the first pulse source and 67% from one or more other pulse sources, 67% of the first pulse source and 33% from one or more other pulse sources, 75% of the first pulse source and 25% from one or more other pulse source 95% of the first pulse source and 5% from one or more other pulse sources, 99% of the first pulse source and 1% from one or more other pulse sources. In these examples, the first pulse source may be any of the pulse sources disclosed herein, and the one or more other pulse sources may be one or more of the pulse sources described herein that is different from the first pulse source.

Pulses additionally be separated into fractions such as protein, starch and fiber. For instance, pulse-base isolates and concentrates may be included in the food products of the present disclosure, e.g., as pulse protein isolate, pulse protein concentrate, pulse starch isolate, pulse starch concentrate, pulse fiber isolate, pulse fiber concentrate. Pulse flour may be enriched or fortified with such fractions or with additional nutrients.

Pulse flour is naturally gluten-free may be a replacement for wheat flour and other flour made from grains. The pulse flour may provide a complete replacement for these other flours in food products. According to the implementations of the present disclosure, food products that contain pulse flour may be gluten-free.

Unlike these prior approaches that teach the ability of the pulse ingredients, particularly to the exclusion of non-pulse ingredients, to produce stable food products, including stable noodle and pasta products, Applicant has discovered that pulse ingredients alone are not sufficient to produce these stable food products and do not form a stable matrix. Accordingly, the food products disclosed herein are pulse-based food products that contain binders to facilitate cohesion of the pulse flour to form a stable product.

The pulse-based food products may contain about 80 to 97 wt % by dry weight of a pulse flour. For instance, pulse flour may account for up to, about, or over 80 wt %, 85 wt %, 90 wt %, 95 wt %, or about 80 to about 95 wt %, about 85 to about 95 wt %, about 90 to about 95 wt %, about 90 to about 97 wt %, or about 80, 85, 86, 87, 88, 89, 90, 91, 92, 93, 94, 95, 96, or 97 wt % of the food product. A balance of the food product contains a binder, optional minor additives and water, as described herein.

Binders of the present disclosure may be powdered seaweed binders, which are natural binder products that have been physically processed to form powders but not chemically processed. The binder may be formed by grinding seaweed, particularly wakame, kombu, mozuku and/or edible seaweeds from the order Laminariales. Wakame is an edible seaweed (Undaria pinnatifida). Kombu is another edible seaweed, particularly, a sea kelp, with members mainly from the family Laminariaceae with edible species such as Saccharina japonica, Saccharina angustata, Saccharina cichorioides, Saccharina coriacea, Saccharina gyrata, Saccharina latissima, Saccharina longipedalis, Saccharina longissima, Saccharina sculpera, and Arthrothamnus bifidus. Mozuku is also edible seaweed species such as Cladosiphon okamuranus, Sphaerotrichia divaricate and Nemacystus decipiens. Other sources of seaweed that may be ground into powdered binders include but are not limited to edible seaweeds from the order Laminariales such as the sea kelp Lessonia nigrescens.

Binders may be present in the food products at about 1 to about 10 wt %, about 2 to about 8 wt %, about 3 to about 6 wt %, or about 2, 3, 4, 5, 6, 7, 8, 9, or 10 wt % of the food product. In some implementations, the binder may be a powdered wakame, kombu, mozuku, and/or edible seaweeds from the order Laminariales, or portions or blends of two or more seaweed powders. For instance, the seaweed binder powder blend may contain 1-99% wakame, with the balance of kombu, mozuku and/or edible seaweeds from the order Laminariales. Examples of these seaweed binder blends include but are not limited to: 50% wakame and 50% kombu, mozuku and/or edible seaweeds from the order Laminariales, 10% wakame and 90% kombu, mozuku and/or edible seaweeds from the order Laminariales, 25% wakame and 75% kombu, mozuku and/or edible seaweeds from the order Laminariales, 33% wakame and 67% kombu, mozuku and/or edible seaweeds from the order Laminariales, 67% wakame and 33% kombu, mozuku and/or edible seaweeds from the order Laminariales, 75% wakame and 25% kombu, mozuku and/or edible seaweeds from the order Laminariales, 90% wakame and 10% kombu, mozuku and/or edible seaweeds from the order Laminariales.

The aforementioned seaweeds naturally contain alginate, which is a known binder in food products. Alginate is present in the cell walls of brown algae as the calcium, magnesium and sodium salts of alginic acid. In typical alginate extraction processes, the magnesium and calcium salts are converted to sodium alginate and extracted along with the natural sodium alginate. The extraction process is a chemical process that can involve acid extraction alone or in combination with calcium chloride and sodium carbonate treatment, to produce alginate binders in the form of alginic acid (acid extraction) or calcium alginate (extraction using acid, calcium chloride and sodium carbonate). During the extraction processes, seaweed residue is removed by filtration.

According to embodiments of the present disclosure, the seaweed powders are not subject to extraction treatment and retain their natural sodium, magnesium and calcium salts of alginic acid. The binders may accordingly be free of chemically extracted alginate. Food products containing the seaweed powder binder therefore contain nutrients and minerals from the seaweed that are not otherwise found in food binders and include magnesium and calcium, potassium, iron, and iodine and vitamins A, C, D, and E, B vitamins, and omega-3 fatty acids. Consequently, food products of the present disclosure contain elevated levels of these seaweed-based nutrients and vitamins compared to food products that do not contain seaweed binders. For instance, food products that use gluten, extracted alginate or other chemical binders contain relatively lower amounts of these nutrients and vitamins compared to the food products disclosed herein that contain the powdered seaweed binder.

In some implementations the powdered seaweed may be derived from the whole seaweed plant, from the seaweed leaf, or from the seaweed roots. The roots of the seaweed may have increased binding properties compared to the leaf due to the roots being nutrient-rich, but powder from both the roots and leaves (e.g., the whole seaweed plant) are effective binders. In some implementations, the whole seaweed plant is ground into seaweed powder to provide the binder. In some implementations, only the root portion of the seaweed is ground into seaweed powder to provide the binder. In other implementations, a blend of powdered roots of the seaweed and powdered leaves of the seaweed may be provided. For instance, a blend of root- and leaf-based powder may contain 1-99% powder derived from leaves of the wakame and/or kombu and/or mozuku and/or edible seaweeds from the order Laminariales, with the balance derived from roots of the wakame and/or kombu and/or mozuku and/or edible seaweeds from the order Laminariales, such as 50% leaves and 50% roots, 1% leaves and 99% roots, 5% leaves and 95% roots, 25% leaves and 75% roots, 33% leaves and 67% roots, 67% leaves and 33% roots, 75% leaves and 25% roots 95% leaves and 5% roots, 99% leaves and 1% roots.

The powdered seaweed, e.g., wakame and/or kombu and/or mozuku and/or edible seaweeds from the order Laminariales, binder may be the primary binder or the sole binder in the food product, and the binder may consist of the seaweed powdered binder. In some implementations, the powdered seaweed binder may consist of a single species of seaweed, such as Saccharina sculpera, or any of the disclosed seaweed species, or may consist of two, three, or four species of seaweed. Further, the powdered seaweed binder may consist of seaweed from wakame, or from kombu, or from mozuku, or from edible seaweeds from the order Laminariales. The food product may exclude non-seaweed-based binders such as chemical binders such as xanthan gum, guar gum, carrageenan, agar, extracted alginate, gum Arabic, ghatti, tragacanth, pectin, gellan, carboxy methylcellulose or locust bean gum, and other polysaccharides.

The powdered seaweed binder may be formed by grinding and have a particle size distribution that is about the same as a particle size distribution as the pulse flour. For instance, the binder may have a particle size of up to about 50 μm or less, 40 μm or less, or 30 μm or less, and the pulse flour may have the same particle size distribution. In another example, about 90% of the powdered binder may have a particle size of about or up to about 50 μm or less, 40 μm or less, or 30 μm or less.

In some implementations, minor additives may be included at about 0.05 wt % to about 5 wt %, about 0.1 wt % to about 5 wt %, about 0.1 wt % to about 3 wt %, about 0.1 wt % to about 2 wt %, about 0.1 wt % to about 1 wt %, about 0.1 wt % to about 0.5 wt %, about 0.5 wt % to about 1 wt %, 0.5 wt % to about 2 wt %, 0.5 wt % to about 3 wt %, or about 0.05, 0.1, 0.2, 0.3, 0.4, 0.5, 0.6, 0.7, 0.8, 0.9, 1.0, 1.5, 2.0, 2.5, 3.0, 3.5, 4.0, 4.5, 5.0, 5.5, 6.0, 7.0, 8.0, 9.0 or 10 wt % of the food product.

Minor additives may include starch (e.g. rice starch, tapioca starch, potato starch), salt (NaCl), vitamins, minerals, kansui, or a blend of sodium carbonate and potassium carbonate (e.g., the primary components of kansui). Where the minor additive is starch or another component that may facilitate with the binding properties of the product, the amount of the minor additives may be insufficient alone to serve as the binder of the food product. Rather, the powdered wakame and/or kombu and/or mozuku and/or edible seaweeds from the order Laminariales may serve as the binder, while optional minor additives may facilitate the binding effects of the binder powder. Some minor additives, however, may not facilitate the binding effect of the powdered binder. Minor that may not facilitate binding may include salt (NaCl), vitamins and minerals. In some implementations, kansui, or sodium carbonate and potassium carbonate may be added for formation of noodle products such as ramen as a texturizer. Potassium carbonate may provide a firmer texture while sodium carbonate provides a softer, chewy texture.

Water or moisture may be present in the food product at about 1% to about 40% by weight of the food product. For instance, a dough may contain about 30-40 wt % moisture, and fresh noodle may contain about 30-35 wt % moisture when uncooked, a dry noodle may contain about 5-20 wt % water when uncooked.

While the food products of the present disclosure may be gluten-free, the products may additionally be soy-, dairy-, and/or egg-free, for instance, to reduce the presence of allergens naturally contained in soy, dairy and eggs. The products may additionally be free of corn and corn-based products such as corn starch.

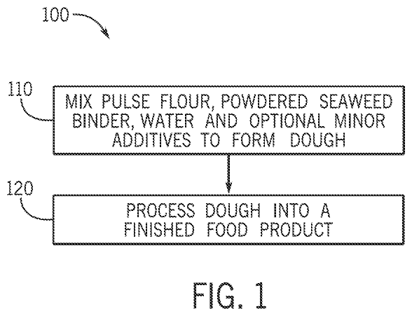

Methods of producing food products according to the present disclosure may follow method 100 illustrated in FIG. 1. Method 100 involves formation of doughs through mixing (step 110) pulse flour, powdered seaweed binder, water and optional minor additives such as salt. The dough components and water may be added to a mixer and mixed until a dough forms. Mixing time may be about 10 to 15 minutes. Mixing facilitates hydrating the pulse flour and causing the binder and the starch from the pulse flour to form a gel and bind into a dough.

Table 1 provides one implementation of a composition of a food product:

TABLE 1

| | | |
|---|---|---|
| Pulse flour | 65-90 | wt % |
| Powdered seaweed binder | 2-10 | wt % |
| Salt | 0-1.0 | wt % |
| Water | 20-35 | wt % |
| Optional additives (starch, vitamins, | 0.5-1.0 | wt % |
| minerals) | | |

In some implementations, the dough may be a finished food product or the dough may optionally be further processed (step 120) into food products such as noodles (fresh, dried), pasta (fresh, dried), dumpling skin, pizza dough, tortillas, and so on, to form the finished food product. In one example, the dough may be processed into fresh noodles such that the dough may be subjected to a resting period, a sheeting process, followed by cutting into noodles, and cooking. The resting process may facilitate further hydration and binding via the seaweed binder. The sheeting process produces a dough layer of desired noodle thickness, such as 1-5 mm. Sheeting may involve using a roller, where a gap in the roller is reduced over several iterations of rolling until the dough reaches the desired thickness. For example, the dough may be rolled five or more times. The noodle may be cut to a desired width, such as about 1-3 mm. The finished food product may therefore be pulse-based and gluten-free. The finished product may be used for consumption as a foodstuff and may optionally be packaged prior to use.

Implementations of the present disclosure are more particularly described in the following Example that is for illustrative purposes only. Numerous modifications and variations are within the scope of the present disclosure as will be apparent to those skilled in the art.

### Example

Farinograph testing was conducted to determine the flour strength of different doughs. The testing methods involved Farinograph (14% moisture basis) that follow the AACC International Method 54-21.02, and all results were adjusted to conform to AACC International methodology. AACC International methodology is described in Appendix A herein.

Pulse-based control doughs analyzed for their flour strength included: MA3 (100% chickpea flour), YP3 (100% yellow pea flour) and RL3 (100% red lentil flour).

The test doughs analyzed for their flour strength contained a seaweed powder binder derived from the order Laminariales was mixed with the pulse-based flours from the control and included: MA3-SS6 (5.7 wt % seaweed powder and 94.3 chickpea flour); YP3-SS6 (5.7 wt % yellow pea powder and 94.3 pulse flour); and RL3-SS6 (5.7 wt % seaweed powder and 94.3 red lentil flour).

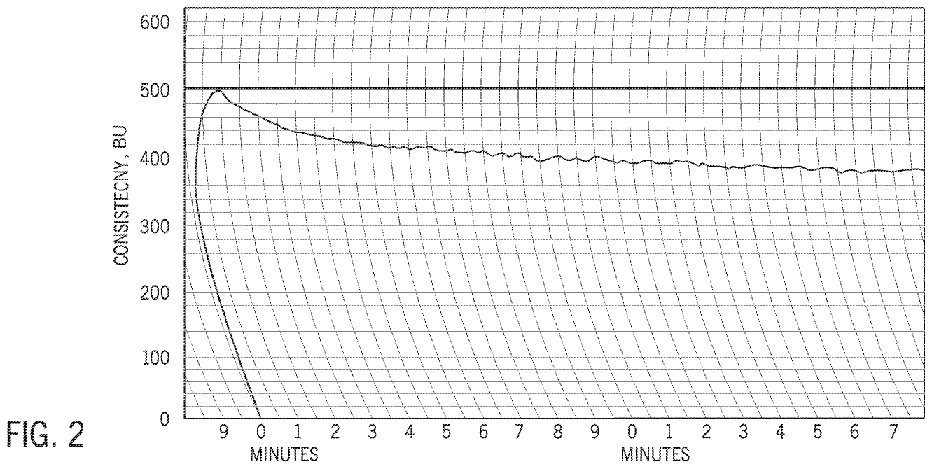

The results in FIGS. 2-7 include farino-plasto-charts for each of the control and test samples analyzed.

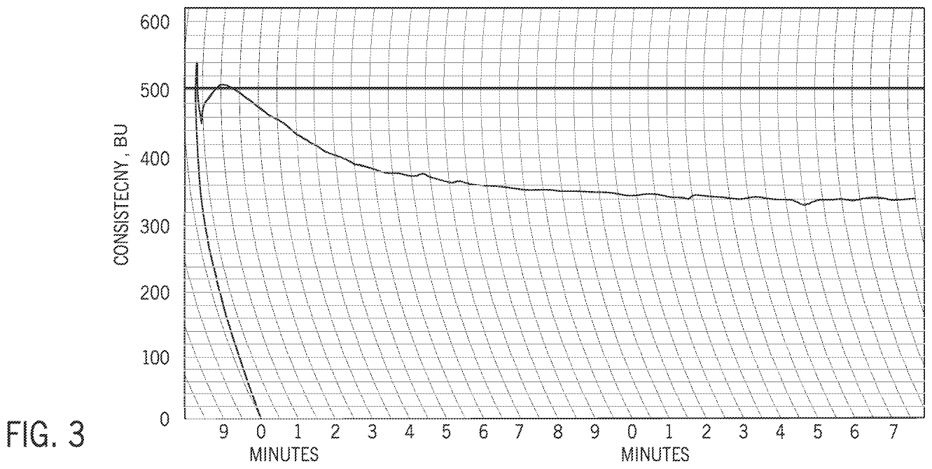

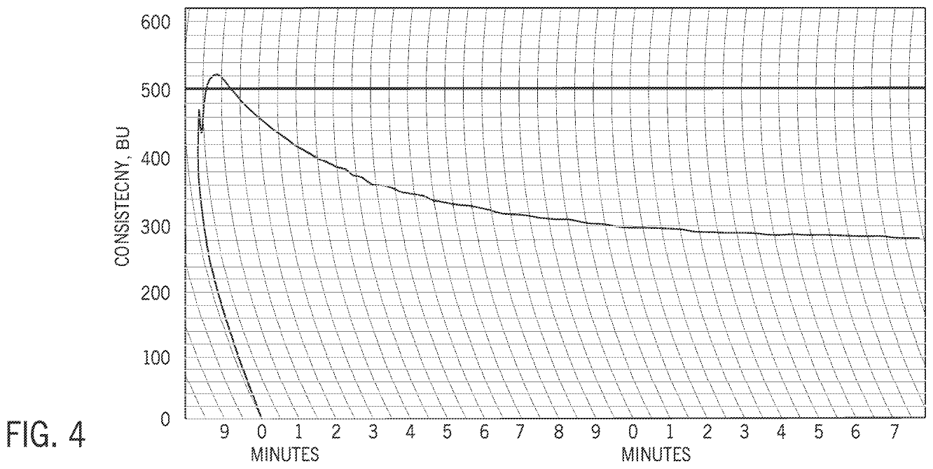

The doughs containing the control pulse flours analyzed (MA3, YP3, and RL3) in FIG. 2 (CTR MA3), FIG. 3 (CTR YP3) and FIG. 4 (CTR RL3) all showed the weakest flour strength as illustrated in FIGS. 2-4. The chickpea flour dough control (CTR MA3) had a peak value at 1 min., stability of 0.5 inches, an absorption of 38.5%, and an M.T.I. value of 80. The yellow pea flour dough control (YP3) had a peak value at 1.25 min., stability of 0.5 inches, and absorption of 43%, and an M.T.I. value of 140. The red lentil flour dough control (RL3) had a peak value at 1 min., stability of 0.25 inches, an absorption of 44.9%, and an M.T.I. value of 180.

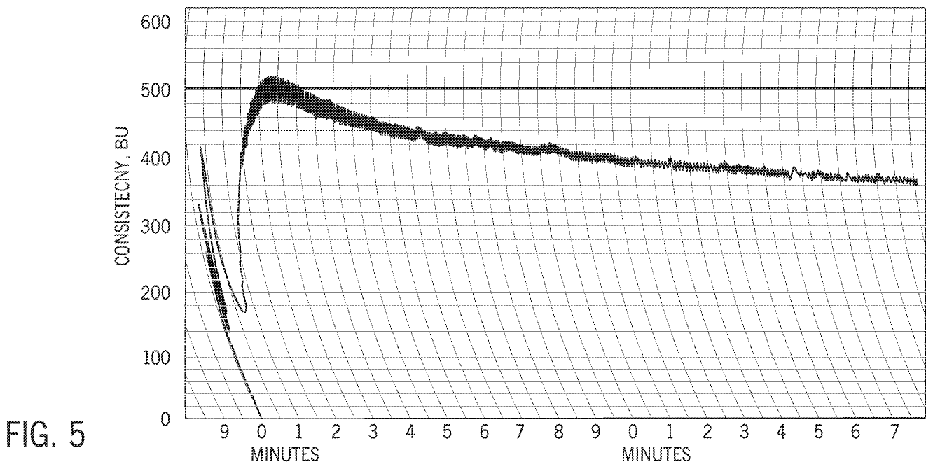

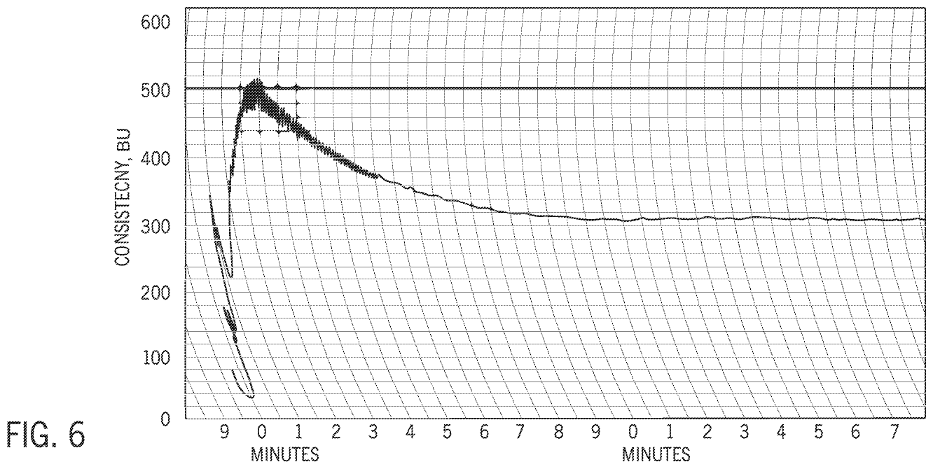

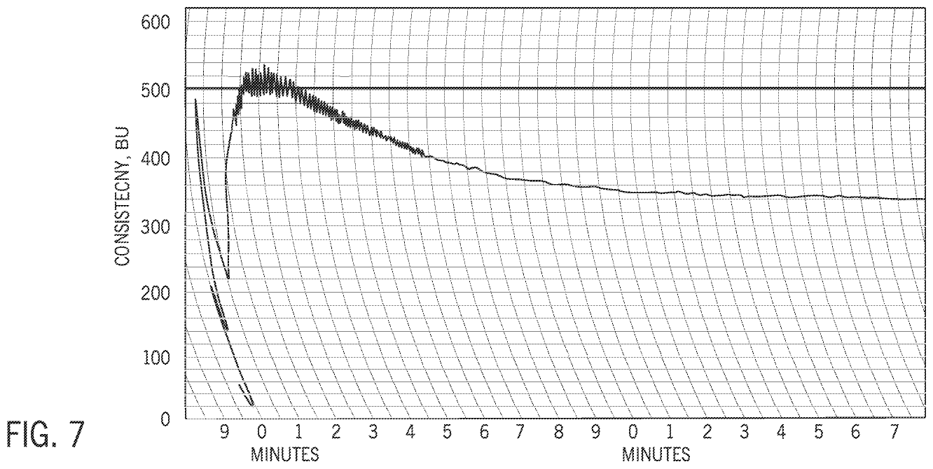

The test doughs containing the seaweed powder binder of the order Laminariales (MA3-SS6, YP3-SS6, RL3-SS6) in FIG. 5 (MA3-SS6), FIG. 6 (YP3-SS6), and FIG. 7 (RL3-SS6) improved dough strength compared to their respective control counterparts and appear to have a medium dough strength. As shown in FIG. 5, the 5.7 wt % seaweed powder and 94.3 chickpea flour dough (MA3-SS6) performed better than the chickpea flour dough control (MA3) of FIG. 2. The seaweed powder increased the MA3-SS6 dough performance and the test dough had a peak value at 2.5 min., stability of 1 inch, an absorption of 61.9%, and an M.T.I. value of 90. As shown in FIG. 6, the 5.7 wt % yellow pea powder and 94.3 pulse flour (YP3-SS6) performed better than the yellow pea flour dough control (YP3) of FIG. 3. The seaweed powder increased the YP3-SS6 dough performance and the test dough had a peak value at 2 min., stability of 0.5 inches, an absorption of 58.0%, and an M.T.I. value of 180. As shown in FIG. 7, the 5.7 wt % seaweed powder and 94.3 red lentil flour (RL3-SS6) performed better than the red lentil flour dough control (RL3) of FIG. 4. The seaweed powder increased the RL3-SS6 dough performance and the test dough had a peak value at 2 min., stability of 1.5 inches, an absorption of 55.6%, and an M.T.I. value of 130.

Accordingly, including seaweed powder binders of the present disclosure improve the strength of pulse-based doughs.

Other examples and implementations are within the scope and spirit of the disclosure and appended claims. For example, the term “exemplary” does not mean that the described example is preferred or better than other examples.

### APPENDIX A

Physical Dough Tests—AACC International Method 54-21.02

Rheological Behavior of Flour by Farinograph: Constant Flour Weight Procedure—Final approval Nov. 8, 1995; revision and approval Jan. 6, 2011

Objective

The Farinograph measures and records the resistance of dough to mixing. It is used to evaluate the absorption of flours and to determine stability and other characteristics of doughs during mixing. Two different procedures are in common use: the constant flour weight procedure, described herein, and the constant dough weight procedure (Method 54-22.01). Since the two procedures may not yield identical results, the method employed must be specified when absorption and other farinogram values are reported.

Apparatus

Brabender Farinograph, with large (300 g flour) and/or small (50 g flour) mixing bowls.

Procedure

Adjustments of Farinograph

1. Adjust the Farinograph thermostat to maintain a temperature of 30±0.2° C. at the entrance to the mixing bowl. Check the temperature of the circulating water with a high-grade thermometer. Make sure that the water is circulating freely through the hose and bowl jackets. Confirm that the flow pattern is the same as shown in the equipment manual.

2. With the help of a spirit level mounted on the base plate, adjust the position of the base plate to horizontal by means of four footscrews. Then fix the foot-screws by means of their locknuts (see equipment manual).

3. Make certain that the chart paper runs exactly horizontally. Two small plates on spring-loaded hinges, at the front of recording device, operate as guides for the paper and may be swung open to make this adjustment. This step does not apply to electronic models

Use of Large and Small Mixing Bowls

In changing from one bowl to another, the following adjustments are involved:

1. Sensitivity. Four sensitivities are provided. There are two choices of position linkage between balance levers (rear and front) and two choices of additional weights (400 and 1000). Normal settings are for the large bowl (300 g), linkage toward the rear of the Farinograph, switch on 1000; for the small bowl (50 g), linkage toward the front of the Farinograph, switch on 400. This step does not apply to electronic models.

2. Zero position of the scalehead pointer. Adjust the scalehead pointer to the zero position of the dial by changing the position of the threaded balance weights when the instrument is running at 63±2 rpm with the mixer empty. The smaller of two weights should be removed entirely when the small bowl is used on older models (from 1978). Make the final writing arm adjustment with the knurled screw on the left side of the scalehead shaft so that the scalehead pointer and writing pen give identical readings. This step does not apply to electronic models.

3. Adjustment of bandwidth. The damping device should be adjusted only after the oil in the damping chamber has been at operating temperature for at least 1 h and after the damping piston has been moved up and down several times. To make the adjustment, raise the dynamometer lever arm until the scalehead pointer indicates 1,000 Brabender units (BU). Release the lever arm and measure with a stopwatch the time required for the pointer to go from 1,000 to 100 BU (Brabender Units) on the scalehead (should be 1±0.2 s). The damping adjustment controls the bandwidth of a farinogram. To obtain a wider damper opening and quicker movement of the scalehead pointer, and thus, a wider curve, turn the adjustment screw counterclockwise. Opposite adjustment produces a narrower band. A bandwidth at the peak of the curve of 70-80 BU is recommended. It may be advantageous to mark the damper adjustment screw at the correct setting. This step does not apply to electronic models.

4. Cleaning. At the completion of each test and while the machine is running, add dry flour to the bowl to make a stiff dough with a consistency of 800-900 BU within 1 min of mixing with the test dough. Then stop the machine, unscrew the bowl wing nuts, take off the front section of the mixing bowl, and discard the dough. Remove any adhering particles quickly before they dry, using a small plastic spatula to scrape the blades and sidewalls of bowl. (The spatula should be of softer material than the mixing bowl in order not to damage the bowl.) Finally, clean the bowl with a dampened cloth and wipe all parts dry, including the space behind the paddles. (Caution: Never use chemical agents such as borax or any dough stiffeners other than flour, since traces of chemicals can affect subsequent curves and may even react with the metal surfaces of the bowl.)

For bronze bowls, put cleaning dough through the mixing bowl every morning, or after the machine has stood idle for several hours, to rub off the thin film of oxidation on the surface. If the preliminary titration of the flour sample is conducted (as explained below), this may be regarded as a cleaning dough. A stainless-steel bowl does not require cleaning dough. Also, after the machine has been standing, small particles of dough may harden between the shafts and blades at the back of the mixing bowl and cause resistance to turning. Correct this by placing a few drops of water on the inside back wall of the bowl directly over the shafts, with blades turning, to soften the dough particles. Then use a strong jet of water or blast of air or CO2 to remove the dough. Return of the scalehead pointer to zero position indicates that these dough particles have been softened and removed.

Clean the titrating burette periodically with a solution made of 10 parts concentrated H2SO4 to 1 part saturated potassium dichromate solution. Fill the burette with this solution and let it stand overnight. This solution is extremely corrosive and should be handled with caution. After draining the burette, rinse repeatedly with tap water and finally with distilled water. After recording each titration, and when not in use, keep the burette, including the tip, filled with water at all times.

Procedure for the Large Bowl

1. Turn on the thermostat and circulating pump at least 1 h prior to using the instrument.

2. Determine the moisture content of the flour as directed in any oven method for flour (Method 44-15.02 and following). (Keep the flour samples in moisture-proof containers. Accurate moisture values are very important.)

3. In the bowl, place 300±0.1 g flour (14% moisture basis). (See Notes 1 and 2 and Table 82-23.01).

4. Fill the large burette with water at room temperature, making sure that the tip is full and the automatic zero adjustment of the burette is functioning properly.

5. Set the pen point at the 9 min mark on the chart. Turn on the machine to the “63 rpm” setting, and run for 1 min until the zero minute line is reached. This step does not apply to electronic models.

At this instant, begin adding water to the right front corner of the bowl from the large burette to a volume nearly that of the expected absorption of flour. When the dough begins to form, scrape down the sides of the bowl with a plastic scraper, starting on the right front side and working counterclockwise. Cover the bowl with a Plexiglas cover to prevent evaporation. If it appears that the mixing curve will level off at a value larger than 500 BU (Brabender Units), cautiously add more water. This will be used to estimate absorption for the next attempt. After the water is added, again cover the bowl with a Plexiglas cover to prevent evaporation.

6. The first titration attempt rarely produces a curve that has maximum resistance centered on the 500 BU line; therefore, in the subsequent titration, adjust absorption either up or down until this is achieved to within 20 BU. Titrations producing wider variation affect the scoring of the curve. As a guide to correcting preliminary titration values, it can be understood that differences between each horizontal line (20 BU) correspond to approximately 0.6-0.8% absorption (1.8-2.4 mL water), depending on the flour. When the correct absorption is achieved, the curve, at the maximum dough development, will be centered on the 500±20 BU line.

7. For the final titration, add all the water within 25 s after opening the burette stopcock. Allow the instrument to run until an adequate curve is available for evaluation as desired (see Interpretation), i.e., absorption, slightly beyond the peak; stability, until the top of the curve re-crosses the 500 BU line after the peak; valorimeter, 12 min beyond the peak. At this point, lift the pen from the paper (does not apply to electronic models) by means of the small locking knob on the pen arm, add dry flour to the bowl, and proceed with cleaning the bowl.

8. Report absorption values to the nearest 0.1%. Calculate the absorption on a 14% moisture basis determined with the large bowl using the following equation:

$$Absorption \% = \frac{( x + y - 300 )}{3}$$

where x=mL of water needed to produce a curve with maximum consistency centered on the 500 BU line, and y=g of flour used, equivalent to 300 g, 14% moisture basis.

Procedure for the Small Bowl

The principle is the same as for the large bowl, except that 50±0.1 g flour (14% moisture basis) is used (See Note 2 and Table 82-23.01). Titration is conducted with the small burette. In this case, each interval between horizontal lines of the chart (20 BU) corresponds to about 0.4 mL water.

Calculate absorption on a 14% moisture basis, determined with the small bowl, using the equation

Absorption %=2(x+y−50)

where x=mL of water needed to produce a curve with maximum consistency centered on the 500 BU line, and y=g of flour used, equivalent to 50 g, 14% moisture basis.

Interpretation

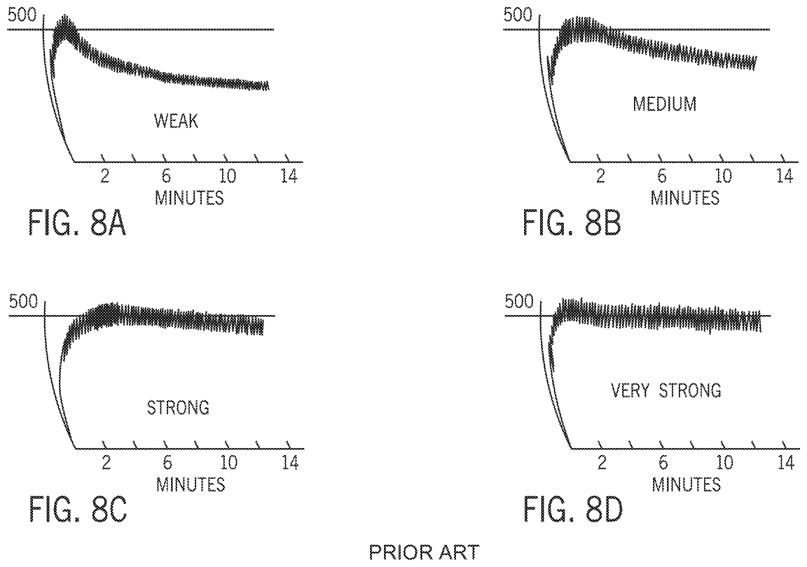

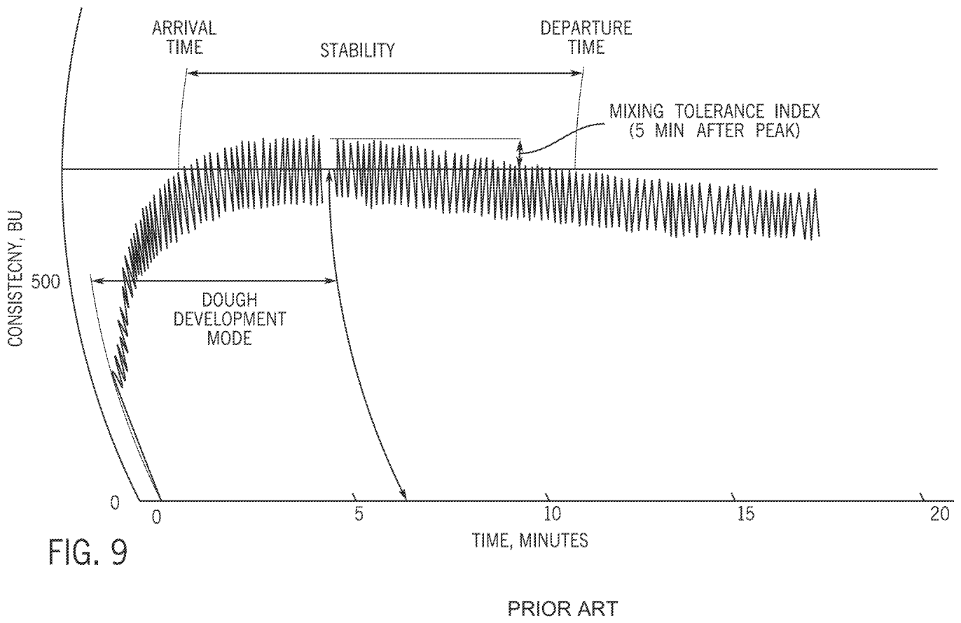

Typical farinograms from flours of different strengths are shown in prior art FIGS. 8A-8D. Values other than absorption are frequently derived from Farinograph curves (FIG. 9 (prior art)). Among those that have been proposed are in FIGS. 8A-8D, which illustrate farinograms from flours of different strengths. FIG. 8A, weak flour: absorption, 54%; dough development time (DDT), 1.25 min; mixing tolerance index (MTI) value, 180. FIG. 8B, medium strength flour: absorption, 57%; DDT, 2.75 min; MTI value, 80. FIG. 8C, strong flour: absorption, 64.5%; DDT, 5 min; MTI value, 30. and FIG. 8D, very strong flour: absorption, 62.7%; apparent DDT, 1.75 min; MTI value, 20. FIGS. 8A-8D Reproduced from D'Appolonia and Kunerth, 1984.

1. Dough development time. This is the interval, to the nearest 0.5 min, from the first addition of water to that point in the maximum consistency range immediately before the first indication of weakening. This value has also been referred to as the “peak” or “peak time.” For flours having a curve that is nearly flat for several minutes, the peak time may be determined by taking the mean between the midpoint of the flat portion of the top of the curve and the highest point of the arc of the bottom of the curve. Occasionally, two peaks may be observed; the second should be taken for the determination of the dough development time.

2. Stability. This is defined as the time difference, to the closest 0.5 min, between the point where the top of the curve first intersects the 500 BU line (arrival time) and the point where the top of the curve leaves the 500 BU line (departure time). If the curve is not centered exactly on the 500 BU line at the maximum resistance, but rather is, for example, at the 490 or 510 BU level, the line must be drawn at the 490 or 510 BU level parallel to the 500 BU line. This new line is then used in place of the 500 BU line to determine the arrival time, departure time, and stability.

3. Mixing tolerance index. This value is the difference in BU from the top of the curve at the peak to the top of the curve measured at 5 min after the peak is reached. The related measurement, called “drop-off;” refers to the difference in BU from the 500 BU line to the center of the curve measured at 20 min from the addition of water. FIG. 9 illustrates a representative farinogram showing some commonly measured indices, which is reproduced from Pomeranz, Y., ed. 1971. Wheat: Chemistry and Technology, 2nd ed. Am. Assoc. Cereal Chem., St. Paul, Minn.

4. Time to breakdown. This is the time from the start of mixing until there has been a decrease of 30 BU from the peak point. It is determined by drawing a horizontal line through the center of the curve at its highest point and then drawing another parallel line at the 30 BU lower level. The time from the start of the mixing until the center of the descending curve crosses this lower line is the “time to breakdown.”

5. Valorimeter value. This is an empirical single-figure quality score based on the dough development time and the tolerance to mixing that is derived from the farinogram by means of a special template supplied by the manufacturers of the Farinograph equipment. To read the valorimeter value, the farinogram is first placed in the valorimeter so that the zero time and the line (normally the 500 BU line) through the center of the farinogram correspond to zero time and the 500 BU line of the dummy Farinograph charts in the valorimeter. After the farinogram is placed in position, the left-hand edge of the movable slide is placed on the peak, or dough development time, of the farinogram; if the curve is flat, it is placed on the first indication of weakening. The valorimeter value is then read at the right-hand edge of the slide, 12 minutes past the peak, and is the value corresponding to the line of the stationary template that intersects the center of the farinogram at this point.

Notes

1. Farinograms of various flours are affected differently by the addition of a malt supplement. In general, an addition of malt shortens dough development time and lowers absorption. Practical evaluation of flour may require an addition of malt in amounts required for proper diastatic activity.

2. Example: If a flour sample contains 12.5% moisture, the amount of flour required for a 300 g test is (86.0/87.5)×300=294.9 g. For the 50 g test, it is (86.0/87.5)×50=49.1 g.

3. Farinograph software provided by the manufacturer employs the constant flour weight procedure.

### REFERENCES

Bailey, C. H. Physical tests of flour quality. Leland Stanford Jr. Univ. Food Res. Inst. Wheat Studies 16:243. (September 1939-May 1940)
Brabender, C. W. 1932. Studies with the Farinograph for predicting the most suitable types of American export wheats and flours for mixing with European soft wheats and flours. Cereal Chem. 9:617-627.
D'Appolonia, B. L., and Kunerth, W. H., eds. 1984. The Farinograph Handbook, 3rd ed. Am. Assoc. Cereal Chem., St. Paul, Minn.
Geddes, W. F., Aitken, T. R., and Fisher, M. H. 1940. The relation between the normal farinogram and the baking strength of Western Canadian wheat. Cereal Chem. 17:528-551.
Johnson, J. A., Shellenber, J. A., and Swanson, C. O. 1946. Farinograms and mixograms as a means of evaluating flours for specific uses. Cereal Chem. 23:388-399.
Locken, L., Laska, S., and Shuey, W. 1972. The Farinograph Handbook. 2nd ed. Am. Assoc. Cereal Chem., St. Paul, Minn.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings. Consequently, variations and modifications commensurate with the teachings, and skill and knowledge of the relevant art, are within the scope of the disclosure.

What is claimed is:

1. A food product, comprising:
pulse flour;
a seaweed powder binder that is chemically unprocessed and retains alginate in native form within the seaweed powder;
water; and
optional minor ingredients
wherein the food product is gluten-free.

2. The food product of claim 1, wherein the seaweed in the seaweed powder binder is from one or more of kombu, wakame, or edible seaweeds from the order Laminariales.

3. The food product of claim 1, wherein the seaweed powder binder is the primary binder in the food product.

4. The food product of claim 1, wherein the seaweed powder binder comprises a portion or a blend of powdered roots of the seaweed and powdered leaves of the seaweed.

5. The food product of claim 1, wherein the seaweed powder binder has a particle size of about 40 μm or less.

6. The food product of claim 5, wherein the pulse flour has a particle size of about 40 μm or less.

7. The food product of claim 1, wherein the seaweed powder binder and the pulse flour have about the same particle size distribution.

8. The food product of claim 1, wherein the pulse flour accounts for over 90 wt % by dry weight of the food product and the seaweed powder binder accounts for about 2 to 10 wt % by dry weight of the food product.

9. The food product of claim 1, wherein the optional minor ingredients account for up to about 5 wt % by dry weight of the food product.

10. The food product of claim 1, wherein the pulse flour comprises a single or two or more pulse sources.

11. The food product of claim 1, wherein the food product is free of chemical binders.

12. The food product of claim 1, wherein the food product is one of a dough, a noodle, a pasta, or a dumpling skin.

13. The food product of claim 12, wherein the food product is a dough and contains about 20-35 wt % water, about 70-90 wt % of the pulse flour, and about 2-10 wt % of the seaweed powder binder.

14. A method of forming a food product, comprising:
mixing pulse flour, a seaweed powder binder that is chemically unprocessed and retains alginate in native form within the seaweed powder, water and optional minor ingredients,
wherein the seaweed powder binder is the primary binder in the food product, and
wherein the food product is gluten-free.

15. The method of claim 14, wherein the seaweed powder binder comprises a portion or a blend of powdered roots of the seaweed and powdered leaves of the seaweed.

16. The method of claim 15, wherein the pulse flour accounts for over 90 wt % by dry weight of the food product and the seaweed powder binder accounts for about 2-10 wt % by dry weight of the food product.

17. The method of claim 16, wherein the food product is one of a dough, a noodle, a pasta, or a dumpling skin.

18. The method of claim 17, wherein the food product is a noodle, and the method further comprises forming the mixture into sheets, cutting the sheets into noodles, and cooking the noodles.

19. The method of claim 14, wherein the food product is a dough and contains about 20-35 wt % water, about 70-90 wt % of the pulse flour, and about 2-10 wt % of the seaweed powder binder.
